(19) United States
(12) Patent Application Publication
(10) Pub. No.: US 2008/0144015 A1
(43) Pub. Date: Jun. 19, 2008

(54) Optical characteristic inspection method, optical characteristic inspection apparatus, and optical characteristic inspection system for optical fiber device

(75) Inventors: Masanori Goto, Hong Kong (CN); Tsutomu Fukai, Hong Kong (CN); Masahiro Onishi, Hong Kong (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd, Hong Kong (CN)

(21) Appl. No.: 11/826,497

(22) Filed: Jul. 16, 2007

(30) Foreign Application Priority Data
Jul. 14, 2006 (JP) 2006-193863

(51) Int. Cl. G01N 21/00

(52) U.S. Cl. 356/73.1

(57) ABSTRACT

An inspection unit, in which a laser source and a reflection measuring module containing a laser source and a light receiver are connected to an optical switch, is connected to an input optical fiber of an optical fiber device. An end of an output optical fiber is beveled and is connected to the light receiver through an adapter. When loss is measured, inspection light from the laser source is input into the light receiver through the input optical fiber, the optical fiber device, and the output optical fiber. When return loss is measured, an optical switch is switched to input inspection light, from the laser source in the reflection measuring module, into the optical fiber device through the input optical fiber, and to input light reflected from the optical fiber device into the light receiver in the reflection measuring module.

### BACKGROUND OF THE INVENTION

1. Field of the Invention

The present invention relates to an optical characteristic inspection method, an optical characteristic inspection apparatus, and an optical characteristic inspection system for an optical fiber device.

2. Description of the Related Art

The optical characteristics of an optical fiber device containing optical fibers must be inspected to check the performance of the optical fiber device after the process for adjusting the optical axes of the optical fibers with respect to each other, or after the process for adjusting the optical axes of functional components and the optical fibers and/or other functional components, or after the process for assembling the casing for enclosing the optical fiber device has been completed. In particular, measurement of loss caused while light is traveling through the optical fiber device and measurement of return loss caused when light enters the optical fiber device are commonly performed and are essential in manufacturing of the optical fiber device.

As stated above, it is essential to conduct inspections of optical characteristics of an optical fiber device to check its performance, especially to measure loss caused while light is traveling through the optical fiber device and to measure return loss caused when light enters the optical fiber device.

Specifically, an inspection apparatus for measuring loss has a construction in which laser source 12 which emits inspection light is connected to input optical fiber 11a of optical fiber device 11 whose characteristics should be inspected, and in which light receiver (power meter) 13 is connected to output optical fiber 11b of optical fiber device 11, as schematically shown in FIG. 1. The amount of input light P1 [dBm] entering optical fiber device 11 from laser source 12 is measured, and the amount of output light P2 [dBm] that is transmitted through optical fiber device 11 and that is received by light receiver 13 is measured. Then, difference P1−P2 [dB] is obtained. Difference P1−P2 [dB] represents loss caused while light is passing through optical fiber device 11.

An inspection apparatus for measuring return loss has a construction in which reflection measuring module 14, which contains a laser source as a light source for measuring return loss and a light receiver (power meter), is connected to input optical fiber 11a of optical fiber device 11 whose characteristics should be inspected, as schematically shown in FIG. 2. The amount of light P1 [dBm] entering optical fiber device 11 from reflection measuring module 14 is measured, and the amount of reflected light P3 [dBm] that is reflected from optical fiber device 11 and that is received by reflection measuring module 14 is measured. Then, difference P1−P3 [dB] is obtained. Difference P1−P3 [dB] represents the return loss.

The inspection apparatus shown in FIGS. 1 and 2 includes a typical measuring system designed for inspecting single-core optical fiber device 11. When optical fiber device 11 having connectors (see Japanese Patent Application Laid-Open No. 294780/95) is connected to the inspection apparatus, the connectors can be connected directly to the components such as laser source 12, light receiver 13, and reflection measuring module 14. On the other hand, an optical fiber device that does not have connectors can be connected to the inspection apparatus through a ferrule temporarily attached to each end of optical fibers 11a, 11b of optical fiber device 11 (see Japanese Patent Laid-Open No. 168061/95), or through bare-fiber adapters, or by directly fusing the ends of optical fibers 11a, 11b to the connecting parts of the components.

When single-core optical fiber device 11 is to be connected to the inspection apparatus that is a return loss measuring system, as shown in FIG. 2, input optical fiber 11a is connected to reflection measuring module 14, whereas output optical fiber 11b is not connected to anything. In particular, when the most commonly used and inexpensive reflection measuring module 14a that receives the total reflection from optical fiber device 11 is used, the end of output optical fiber 11b to which nothing is connected must be terminated so as to prevent reflection from the end face of output optical fiber 11b. The termination is typically made by immersing the end face of output optical fiber 11b in matching oil having a refraction index approximately equal to that of output optical fiber 11b, or by wrapping output optical fiber 11b around a rod having a small diameter. The termination is absolutely necessary in measurement of return loss.

There is a need that the measurement process used in optical characteristic inspection for optical fiber devices 11 be simplified and that multiple different inspections be conducted with a single inspection apparatus by simple and quick switching between them. However, it is difficult to readily and quickly switch between measurement of loss and measurement of return loss because output optical fiber 11b must be terminated before measuring return loss, as described above.

### SUMMARY OF THE INVENTION

An object of the present invention is to provide an optical characteristic inspection method, an optical characteristic inspection apparatus, and an optical characteristic inspection system for an optical fiber device, that do not require termination of optical fibers and enable easy and quick switching between measurement of loss and measurement of return loss.

A method for inspecting optical characteristics of an optical fiber device according to the present invention comprises steps of: connecting an input optical fiber of an optical fiber device to be inspected to an inspection unit including a light source which emits inspection light and a reflected light receiver; connecting an output optical fiber of the optical fiber device to a transmitted light receiver, the output optical fiber having a beveled end; and selectively performing reception, by the transmitted light receiver, of transmitted light out of the inspection light entering from the inspection unit into the optical fiber device through the input optical fiber, and reception, by the reflected light receiver, of reflected light out of the inspection light entering from the inspection unit into the optical fiber device through the input optical fiber, the transmitted light being transmitted through the optical fiber device and the output optical fiber, and the reflected light being reflected from the optical fiber device.

With this method, transmitted light and reflected light can be received without disconnecting and reconnecting the optical fibers. In addition, it is unnecessary to terminate the end of the output optical fiber before receiving reflected light. Accordingly, the efficiency of inspection is significantly increased as compared with the case where separate inspection apparatuses are used for receiving transmitted light and for receiving reflected light and where termination is applied to the end of the output optical fiber before receiving reflected light.

The inspection unit may comprise a reflection measuring module, which includes the light source and the reflected light receiver, and another light source, the reflection measuring module and the another light source being connected to an optical switch. In that case, selection between the reception of the transmitted light by the transmitted light receiver and the reception of the reflected light by the reflected light receiver may be performed by switching of the optical switch. With this method, selection between the above-mentioned reception of transmitted light and the above-mentioned reception of reflected light can be readily performed by only a switching operation of the optical switch.

Loss caused by the optical fiber device may be measured by the reception of the transmitted light by the transmitted light receiver, and return loss caused by the optical fiber device may be measured by the reception of the reflected light by the reflected light receiver. Thus, important optical characteristics of the optical fiber device can be readily inspected.

Preferably, an end of the output optical fiber of the optical fiber device is cut at an angle of 8 degrees or more with respect to a plane perpendicular to the longitudinal direction of the output optical fiber.

An apparatus for inspecting optical characteristics of an optical fiber device according to the present invention comprises: an inspection unit including a light source which emits inspection light and a reflected light receiver; and a transmitted light receiver; the inspection unit being connectable with an input optical fiber of an optical fiber device to be inspected, and the transmitted light receiver being connectable with an output optical fiber having a beveled end of the optical fiber device.

The inspection unit may have a construction in which a reflection measuring module, which includes the light source and the reflected light receiver, and another light source are connected to an optical switch.

The transmitted light receiver may receive the transmitted light to measure loss caused by the optical fiber device, and the reflected light receiver may receive the reflected light to measure return loss caused by the optical fiber device.

Preferably, the transmitted light receiver includes an adapter for connecting an end of the output optical fiber of the optical fiber device, the end being cut at an angle of 8 degrees or more with respect to a plane perpendicular to the longitudinal direction of the output optical fiber.

An optical characteristic inspection system for an optical fiber device comprises: an optical characteristic inspection apparatus for an optical fiber device that has any one of the above-mentioned configurations; and the optical fiber device comprising the input optical fiber and the output optical fiber having a beveled end.

According to the present invention, transmitted light which is transmitted through an optical fiber device and reflected light which is reflected from the optical fiber device can be received with a single inspection apparatus to which the optical fiber device is kept attached, without changing the connection. Therefore, processes required for inspection can be simplified and efficiency of the inspection can be improved by the present invention. Furthermore, if the end of the output optical fiber of the optical fiber device is beveled, light reflected off the end face is prevented from traveling through the optical fiber. Therefore, the need to terminate the end face is eliminated and accordingly efficiency of inspection work is improved. In addition, switching from reception of reflected light to reception of transmitted light can be done immediately.

The above and other objects, features and advantages of the present invention will become apparent from the following description with reference to the accompanying drawings which illustrate examples of the present invention.

### BRIEF DESCRIPTION OF THE DRAWINGS

FIG. 1 is a schematic diagram showing an optical characteristic inspection apparatus according to the related art;

FIG. 2 is a schematic diagram showing another exemplary optical characteristic inspection apparatus according to the related art;

FIG. 3 is a schematic diagram showing an optical characteristic inspection apparatus according to one embodiment of the present invention; and

FIG. 4 is an enlarged view showing the end face of an optical fiber of an optical fiber device to be inspected by the optical characteristic inspection apparatus shown in FIG. 3.

### DETAILED DESCRIPTION OF THE PREFERRED EMBODIMENTS

An embodiment of the present invention will be described below with reference to the accompanying drawings.

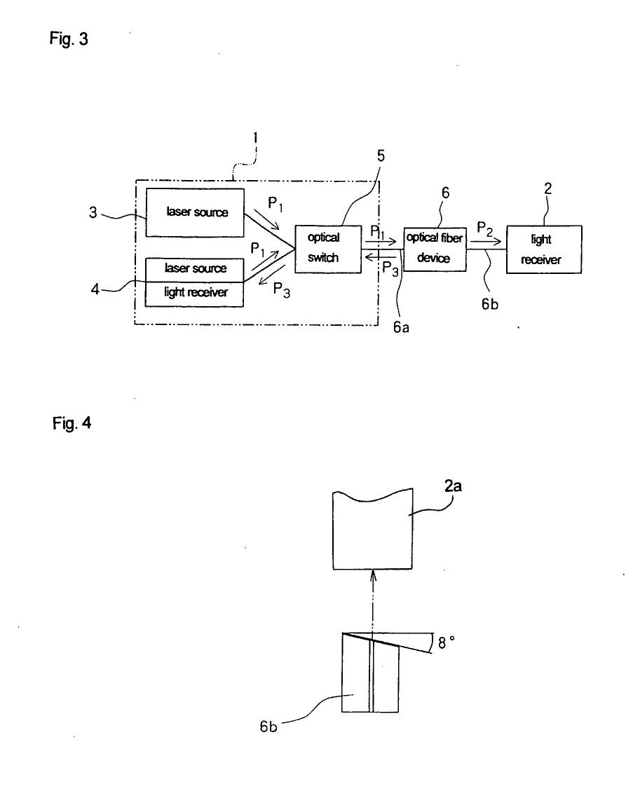

FIG. 3 shows an optical characteristic inspection apparatus for an optical fiber device according to the present invention. The inspections apparatus of the embodiment includes inspection unit 1 and light receiver (power meter) 2. Inspection unit 1 includes laser source 3 which is a light source for measuring loss, and reflection measuring module 4 containing a laser source used as a light source for measuring return loss and another light receiver (power meter). Both laser source 3 and reflection measuring module 4 are connected to optical switch 5.

When inspecting optical characteristics, input optical fiber 6a of single-core optical fiber device 6 to be inspected is connected to optical switch 5 of inspection unit 1, and output optical fiber 6b is connected to light receiver 2. The end of output optical fiber 6b is beveled before connecting to light receiver 2. In particular, a commonly used cleaver (not shown) is used to bevel the end of optical fiber 6b at an angle of 8 degrees as shown in FIG. 4, and the beveled end is connected to light receiver 2 through adapter 2a. Adapter 2a may be a well-known conventional bare fiber adapter and therefore its description of will be omitted.

As described above, in order to set optical fiber device 6 in the inspection apparatus and to inspect its optical characteristics, loss measurement mode or return loss measurement mode is selected by manual control or by control from external equipment. When loss is to be measured, optical switch 5 is turned to the position that will connect laser source 3 to the end face of input optical fiber 6a. Inspection light is emitted from laser source 3, and the inspection light travels through input optical fiber 6a to optical fiber device 6. After passing through optical fiber device 6, the light enters light receiver 2 through output optical fiber 6b. The amount of input light P1 [dBm] entering optical fiber device 6 from laser source 3 and the amount of output light P2 [dBm] received at light receiver 2 are measured. Then, the difference between the amounts, which is loss P1−P2 [dB], is obtained. Loss can be measured in this way.

On the other hand, when return loss is to be measured, optical switch 5 is turned to the position that will connect reflection measuring module 4 to the end face of input optical fiber 6a. Inspection light is emitted from the laser source in reflection measuring module 4, and the inspection light travels through input optical fiber 6a to optical fiber device 6. Then, light reflected from optical fiber device 6 enters the light receiver in reflection measuring module 4 through input optical fiber 6b. The amount of input light P1 [dBm] entering optical fiber device 6 from the laser source in reflection measuring module 4 and the amount of reflected light P3 [dBm] received at the light receiver in reflection measuring module 4 are measured. Then the difference between the amounts, which is return loss P1−P3 [dB], is obtained. Return loss can be measured in this way.

If light reflected off the end face of output optical fiber 6b is contained in the amount of reflected light P3 during the measurement of return loss, the return loss of optical fiber device 6 itself cannot be actually measured. Therefore, conventionally, termination is applied to the end face of output optical fiber 6b to prevent reflection at the end face of output optical fiber 6b. However, termination is troublesome and reduces the efficiency of inspection work. In addition, it is difficult to connect terminated output optical fiber 6b to light receiver 2 in order to conduct loss measurement. That is, it is not easy to switch to loss measurement after the end face of output optical fiber 6b is terminated in order to measure the return loss.

In contrast, according to the present embodiment, reflection at the end face can be prevented without the need for termination, because the end of output optical fiber 6b is beveled (at an angle of 8 degrees). If light reflected off the end face of output optical fiber 6b enters the core of output optical fiber 6b, the reflected light cannot satisfy total reflection conditions because the end is beveled, therefore the reflected light cannot travel through output optical fiber 6b. That is, the same effect as that of termination of the end of output optical fiber 6b can be achieved. Accordingly, return loss can be accurately measured. It is known that the critical angle of total reflection of optical fiber is typically 8 degrees. Therefore, by cutting the end of output optical fiber 6b at an angle of 8 degrees or more, as in the present embodiment, if reflected light reenters output optical fiber 6b, it is prevented from satisfying total reflection conditions and is immediately attenuated without traveling through output optical fiber 6b.

Furthermore, according to the present embodiment, reflection at the end face of output optical fiber 6b does not need to be considered, and therefore the precision of the relative positions of optical fiber device 6 and output optical fiber 6b with respect to light receiver 2 does not need to be very high. Consequently, the efficiency of inspection work increases.

According to the present embodiment, switching from return loss measurement to loss measurement can be readily and immediately made simply by operating optical switch 5. Because the end of output optical fiber 6b is not terminated and is connected to light receiver 2 through adapter 2a, measurement of loss is not hindered. Of course, the beveled end of output optical fiber 6b does not hinder transmission of light to light receiver 2, and therefore does not adversely affects measurement of loss.

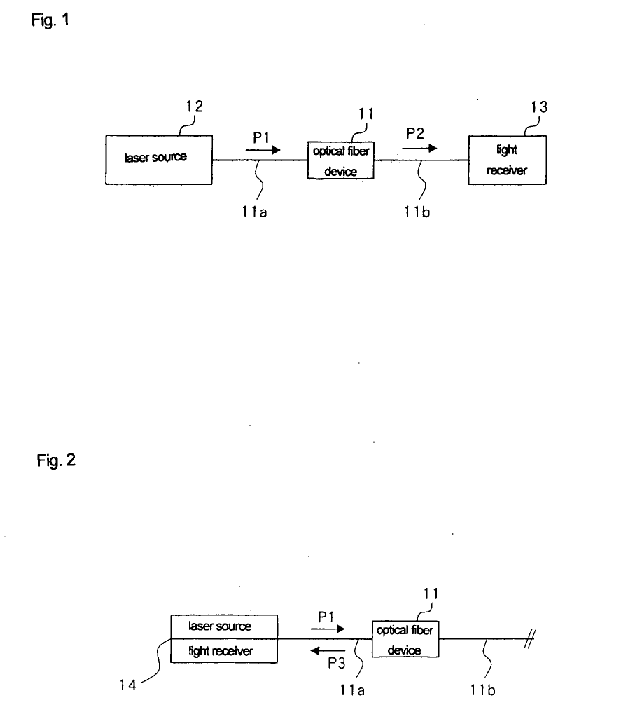

According to the present embodiment, because the end of output optical fiber 6b of optical fiber device 6 is beveled, as described above, transmitted light required for measurement of loss can be received by light receiver 2, and reflection at the end face of optical fiber 6b can be prevented. Therefore, switching between measurement of return loss and measurement of loss can be done quickly and readily by flicking of optical switch 5 without the need for disconnecting and reconnecting the optical fibers. Thus, the number of man-hours can be reduced by approximately 40% compared with the related art in which separate inspection apparatuses are used for measuring loss and for measuring return loss (see FIGS. 1 and 2).

Furthermore, because the end of output optical fiber 6b is beveled, the output angle of light from output optical fiber 6b is increased. Therefore, transmitted light can be measured with a detector having a large light receiving diameter without substantial loss, depending on the distance between the end of output optical fiber 6b and light receiver 2. For example, if the distance between the end of optical fiber 6b and light receiver 2 is approximately 8 mm, measurement can be efficiently performed by using light receiver 2 having a light receiving diameter of 10 mm.

According to the present embodiment, because adapter 2a is provided in light receiver 2, optical fiber device 6 that does not have a connector can be inspected.

The present invention is not limited to configurations including single-core optical fibers 6a, 6b. The present invention can also be readily applied to a configuration including a optical fiber tape structure in which many single-core optical fibers are arranged, by beveling the end of each fiber.

While preferred embodiments of the present invention have been described using specific terms, such description is for illustrative purposes only, and it is to be understood that changes and variations may be made without departing from the spirit or scope of the following claims.

What is claimed is:

1. A method for inspecting optical characteristics of an optical fiber device, comprising the steps of:
connecting an input optical fiber of an optical fiber device to be inspected to an inspection unit including a light source which emits inspection light and a reflected light receiver;
connecting an output optical fiber of an optical fiber device to a transmitted light receiver, said output optical fiber having a beveled end; and
selectively performing reception, by said transmitted light receiver, of transmitted light out of inspection light entering from said inspection unit into said optical fiber device through said input optical fiber, said transmitted light being transmitted through said optical fiber device and said output optical fiber, and reception, by said reflected light receiver, of reflected light out of inspection light entering from said inspection unit into said optical fiber device through said input optical fiber, said reflected light being reflected from said optical fiber device.

2. A method for inspecting optical characteristics of an optical fiber device according to claim 1, wherein
said inspection unit comprises a reflection measuring module, which includes said light source and said reflected light receiver, and another light source, said reflection measuring module and said another light source being connected to an optical switch, and
selection between said reception of said transmitted light by said transmitted light receiver and said reception of said reflected light by said reflected light receiver is performed by switching of said optical switch.

3. A method for inspecting optical characteristics of an optical fiber device according to claim 1, wherein
loss caused by said optical fiber device is measured by said reception of said transmitted light by said transmitted light receiver; and
return loss caused by said optical fiber device is measured by said reception of said reflected light by said reflected light receiver.

4. A method for inspecting optical characteristics of an optical fiber device according to claim 1, wherein
an end of said output optical fiber of said optical fiber device is cut at an angle of 8 degrees or more with respect to a plane perpendicular to the longitudinal direction of said output optical fiber.

5. An apparatus for inspecting optical characteristics of an optical fiber device, comprising:
an inspection unit including a light source which emits inspection light and a reflected light receiver, and
a transmitted light receiver,
said inspection unit being connectable with an input optical fiber of an optical fiber device to be inspected, and said transmitted light receiver being connectable with an output optical fiber having a beveled end of said optical fiber device.

6. An apparatus for inspecting optical characteristics of an optical fiber device according to claim 5, wherein
said inspection unit comprises a reflection measuring module, which includes said light source and said reflected light receiver, and another light source, said reflection measuring module and said another light source being connected to an optical switch.

7. An apparatus for inspecting optical characteristics of an optical fiber device according to claim 5, wherein
said transmitted light receiver receives said transmitted light to measure loss caused by said optical fiber device; and
said reflected light receiver receives said reflected light to measure return loss caused by said optical fiber device.

8. An apparatus for inspecting optical characteristics of an optical fiber device according to claim 5, wherein
said transmitted light receiver includes an adapter for connecting an end of said output optical fiber of said optical fiber device, said end being cut at an angle of 8 degrees or more with respect to a plane perpendicular to the longitudinal direction of said output optical fiber.

9. A system for inspecting optical characteristics of an optical fiber device, comprising:
said apparatus for inspecting optical characteristics of an optical fiber device according to claim 5; and
said optical fiber device comprising said input optical fiber and said output optical fiber having a beveled end.
